(19) United States
(12) Patent Application Publication
(10) Pub. No.: US 2018/0129776 A1
(43) Pub. Date: May 10, 2018

(54) METHOD AND DEVICE FOR SELECTING AND OPTIMIZING ENZYME FOR CATALYSIS

(71) Applicant: Samsung Electronics Co., Ltd., Suwon-si (KR)

(72) Inventors: Anirban Bhaduri, Bangalore (IN); Tadi Venkata Siva Kumar, Bangalore (IN); Taeyong Kim, Daejeon (KR); Yukyung Jung, Hwaseong-si (KR)

(21) Appl. No.: 15/805,980

(22) Filed: Nov. 7, 2017

(30) Foreign Application Priority Data
Nov. 7, 2016 (IN) 201641037915
Feb. 23, 2017 (KR) 10-2017-0024278

(51) Int. Cl. G06F 19/12; G06F 19/18; G06F 19/22; G06F 19/24

(52) U.S. Cl. CPC G06F 19/12; G06F 19/24; G06F 19/22; G06F 19/18

(57) ABSTRACT

Methods and devices for selecting and optimizing an enzyme that catalyzes an input reaction. Known methods for in-silico selection and engineering of an enzyme are computationally intensive and have faulty accuracy. However, the present methods and devices rapidly and accurately screen multiple enzymes and optimize the same for an input reaction by performing stages including enzyme selection, enzyme assessment, and enzyme position scoring. Significant enhancement of the efficacy of the enzyme in a chemical reaction may be achieved through enzyme optimization.

### CROSS-REFERENCE TO RELATED APPLICATIONS

This application claims the benefit of Indian Patent Application No. 201641037915, filed on Nov. 7, 2016, in the Indian Patent Office and Korean Patent Application No. 10-2017-0024278, filed on Feb. 23, 2017, in the Korean Intellectual Property Office, the disclosures of which are incorporated by reference herein in their entireties.

### BACKGROUND

### 1. Field

The present disclosure relates to methods and devices for selecting and optimizing an enzyme that catalyzes a biochemical reaction or a chemical reaction.

### 2. Description of the Related Art

Optimized bioprocessing requires selection and engineering of an enzyme for a given reaction. In-silico selection and engineering of an enzyme for a reaction may be challenging. These methods are computationally intensive, and their faulty accuracy leaves more to be desired. Moreover, there is no method for automatically and accurately identifying and engineering enzymes for an input synthetic reaction.

In addition to in-silico selection of enzymes, synthetic reactions catalyzed within an organism also require enzyme selection and engineering for process optimization.

The general method may be considered to include two steps. The first step includes screening and selecting enzyme(s) for catalyzing an input reaction. In the second step, a selected set of enzymes is assessed to predict residues for engineering. A purpose of engineering and optimization is to alter a function of the enzyme and/or to introduce a novel function into the enzyme. A state-of-the-art technique often accomplishes the first step through measurement of a transformation similarity or a reaction similarity derived only from a molecular fingerprint. Although it is effective, such method may have limited accuracy. Alternatively, such method may also be achieved through large-scale docking or quantitative structure-activity relationship (QSAR) analyses. The computationally intensive second step of the method pertaining to selecting residues or a site on the enzyme for engineering is performed through molecular dynamics or docking.

Therefore, there is a need for methods and devices which can rapidly and accurately screen multiple enzymes and optimize the same for an input reaction.

### SUMMARY

Provided are methods and devices for selecting and optimizing an enzyme that catalyzes a biochemical reaction or a chemical reaction. Additional aspects will be set forth in part in the description which follows and, in part, will be apparent from the description, or may be learned by practice of the disclosed embodiments.

Additional aspects will be set forth in part in the description which follows and, in part, will be apparent from the description, or may be learned by practice of the presented embodiments.

According to an aspect of an embodiment, a method of selecting and optimizing an enzyme for catalysis includes receiving an input reaction, preparing a test reaction to be searched for in a first knowledgebase for the received input reaction, identifying similar biochemical reactions and associated enzymes for the test reaction from the first set of the knowledgebase based on a similarity score, selecting an associated enzyme based on a similarity score of at least one of the identified similar biochemical reactions and a substrate associated with the test reaction, computationally selecting conserved residues of the selected associated enzyme, dividing the conserved residues of the selected associated enzyme into a plurality of sub-structures, computationally selecting one or more residues showing an affinity for substrates binding onto the selected associated enzyme, computing a mutation impact score for each of the one or more selected residues, and selecting a residue of the selected associated enzyme for engineering and optimizing a catalysis of the input reaction, based on the computed mutation impact score.

According to an aspect of another embodiment, a device for selecting and optimizing an enzyme for catalysis includes a memory and one or more processors connected to the memory and configured to receive an input reaction, to prepare a test reaction to be searched for in a first knowledgebase for the received input reaction, to identify similar biochemical reactions along with associated enzymes for the test reaction from the first knowledgebase based on a similarity score, to select an associated enzyme based on a similarity score of at least one of the identified similar biochemical reactions and a substrate associated with the test reaction, to computationally select conserved residues of the selected associated enzyme, to divide the conserved residues of the selected associated enzyme into a plurality of sub-structures, to computationally select one or more residues showing an affinity for substrates binding onto the selected associated enzyme, to compute a mutation impact score for each of the one or more selected residues, and to select a residue of the selected associated enzyme, based on the computed mutation impact score, for engineering and optimizing a catalytic reaction to the input reaction.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart of a method of selecting and optimizing an enzyme that catalyzes an input reaction, according to an embodiment;

FIG. 2 is a flowchart of a method of selecting an enzyme by transforming an input reaction into a test reaction, according to an embodiment;

FIG. 3 is a view for describing computation of a similarity score between a reaction obtained from a knowledgebase and an input reaction, according to an embodiment;

FIG. 4 is a graph for describing optimization of formaldehyde (FA) dehydrogenase (FAcD) and an impact of resulting mutations at a site reporting enhanced activity, according to an embodiment; and

FIG. 5 is a block diagram of a device for selecting and optimizing an enzyme that catalyzes an input reaction, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Although terms used in the present disclosure are selected with general terms popularly used at present under the consideration of functions in the present disclosure, the terms may vary according to the intention of those of ordinary skill in the art, judicial precedents, or introduction of new technology. In addition, in a specific case, the applicant voluntarily may select terms, and in this case, the meaning of the terms is disclosed in a corresponding description part of the disclosure. Thus, the terms used in the present disclosure should be defined not by the simple names of the terms but by the meaning of the terms and the contents throughout the present disclosure.

In a description of the embodiments, when a part is connected to another part, the part is not limited to being only directly connected to another part but also indirectly connected (e.g., electrically) to another part with another device intervening between them. If it is assumed that a certain part includes a certain component, the term ‘including’ means that a corresponding component may further include other components unless a specific meaning opposed to the corresponding component is written. The term used in the embodiments such as “unit” or “module” indicates a unit for processing at least one function or operation, and may be implemented in hardware, software, or in a combination of hardware and software.

The term such as “comprise” or “include” used in the embodiments should not be interpreted as including all of elements or operations described herein, and should be interpreted as excluding some of the elements or operations or as further including additional elements or operations.

The following description of the embodiments should not be construed as limiting the scope of the embodiments, and what may be easily deduced by those of ordinary skill in the art should be construed as falling within the scope of the embodiments. Hereinafter, the embodiments for illustration will be described in detail with reference to the accompanying drawings.

Embodiments of the present disclosure provide methods and devices for selecting and optimizing an enzyme that catalyzes at least one of a chemical reaction, a partial chemical reaction, a chemical pathway, and a substrate.

A method according to an embodiment provides not only information about an enzyme set that catalyzes an input synthetic chemical reaction, but also information about all amino-acids/residues having a mutation impacting upon catalytic activity of a reported enzyme.

According to an embodiment, a method and a device for selecting and optimizing an enzyme that catalyzes an input reaction is disclosed. Herein, the input reaction may include at least one of a chemical reaction, a partial chemical reaction, a chemical pathway, and a substrate.

A method according to the current embodiment may be divided into three connected stages including an enzyme selection stage, an enzyme assessment stage, and an enzyme position scoring stage. Subsequently, engineering and optimization of the enzyme may be performed.

The enzyme selection stage may broadly include identifying a list of enzymes catalyzing similar reaction(s) to an input reaction, using a first set of information in a knowledgebase (e.g., comprising one database or multiple disparate databases). Hereinafter, “first knowledgebase” will be used to refer to a first set of information within a knowledgebase; similarly “second knowledgebase” will be used to refer to a second set of information in a knowledgebase. The first knowledgebase and the second knowledgebase may comprise the same or different databases, or partially overlapping portions of the same databases, and the information in the first knowledgebase (i.e., first set of information” may include the same information as, or different information than, the second knowledgebase). The similar reaction(s) is/are identified by computing a reaction similarity between the input reaction and reactions in the knowledgebase. Computation of the reaction similarity is performed based on substrates in the input reaction/substrates associated with the input reaction and physiochemical properties. An enzyme of similar reaction(s) selected based on a pre-defined threshold is included in a list of candidate enzymes for the input reaction.

The first knowledgebase may include at least one of information regarding substrate(s) and enzyme(s) corresponding to a set of chemical reactions and enzymes, and a list of enzymes.

In the enzyme assessment stage, the assessment of ranked enzymes may be performed as below. The assessment may include computing a conservation score of each residue/amino acid of a ranked and selected enzyme, computationally determining conserved and interacting amino-acids/residues of the selected enzyme, and computing a substrate affinity of identified conserved residue(s).

Next, the enzyme position scoring stage may include computationally scoring each residue's functional impact based on conservation, a substrate affinity, and interaction with other conserved residues, and computationally scoring a mutational importance based on a functional impact and a deviation between the input reaction and a native substrate of the selected enzyme to which the selected enzyme binds.

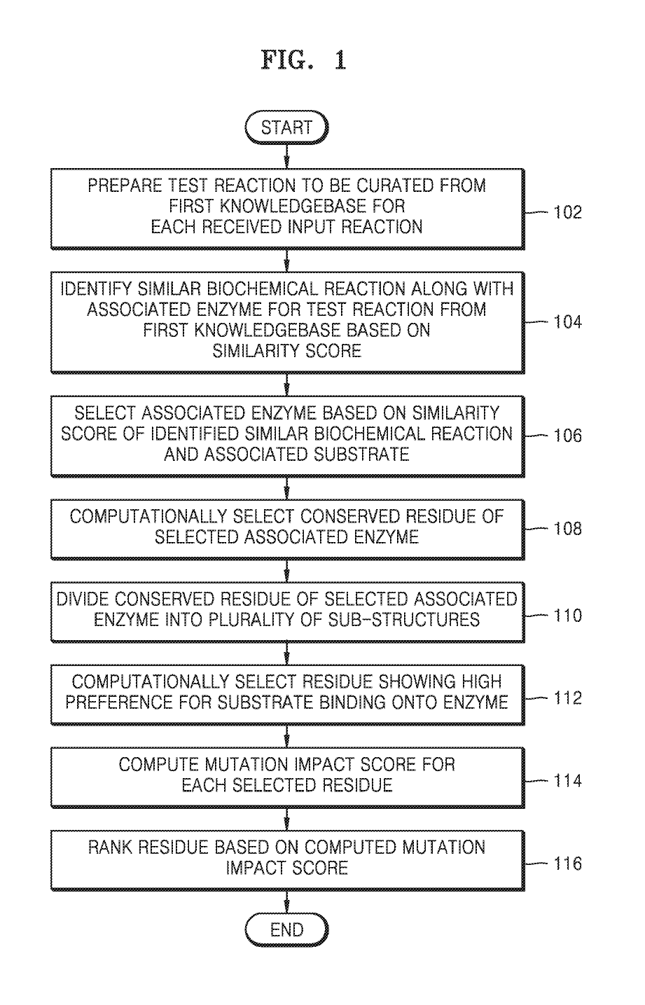

FIG. 1 is a flowchart of a method of selecting and optimizing an enzyme that catalyzes an input reaction, according to an embodiment.

In operation 102, for each received input reaction, a test reaction(s) is/are prepared, which is/are to be curated from the first knowledgebase. Information related to molecular properties is extracted for the received input reaction, and associated substrate(s) may be represented in the form of a simplified molecular-input line-entry system (SMILES). The test reaction is prepared by analyzing the received input reaction to identify at least one of the chemical reaction(s) and associated substrate(s) or by deriving the same from the first knowledgebase if not present in the input reaction. As mentioned earlier, the input reaction may include a chemical reaction, a partial chemical reaction, a chemical pathway, a substrate, or a combination thereof (e.g., a chemical reaction and a chemical pathway, or two chemical reactions, or two chemical reactions and one or two substrates, etc.).

It is known that a synthetic chemical reaction provided as an input reaction may include information about associated substrates, reaction rules, and enzyme(s).

In a scenario where the input reaction includes the substrate(s), a chemical reaction corresponding to the input reaction is derived from the first knowledgebase. In another scenario where the input reaction includes a partial reaction(s), similarly, the missing information is derived from the first knowledgebase to make the chemical reaction complete.

In a further scenario where the input reaction includes a chemical pathway, during an analysis, the pathway is broken into individual reaction steps.

Once the chemical reaction(s) and associated substrate(s) are identified, the same are transformed into a test reaction which is to be searched for in the first knowledgebase. Each input is transformed into one test reaction. The test reaction includes one chemical reaction and associated substrate(s). Substrates associated with the test reaction are obtained from the first knowledgebase.

In operation 104, similar biochemical reaction(s) along with associated enzyme(s) are identified for the test reaction from the first knowledgebase based on a similarity score.

The similarity score is computed based on molecular properties and/or molecular signatures of the substrate(s) associated with the test reaction. The molecular properties include a mass of the substrate(s), charge distribution on the substrate(s), a volume of the substrate(s), stereochemistry of the substrate(s), and so forth. The molecular signature includes chemical descriptors of the substrate(s).

In operation 106, the associated enzyme(s) is/are selected based on the similarity score of the identified similar biochemical reaction(s) and the associated substrate(s). The associated enzyme(s) is/are selected for further processing when the similarity score is above a defined threshold.

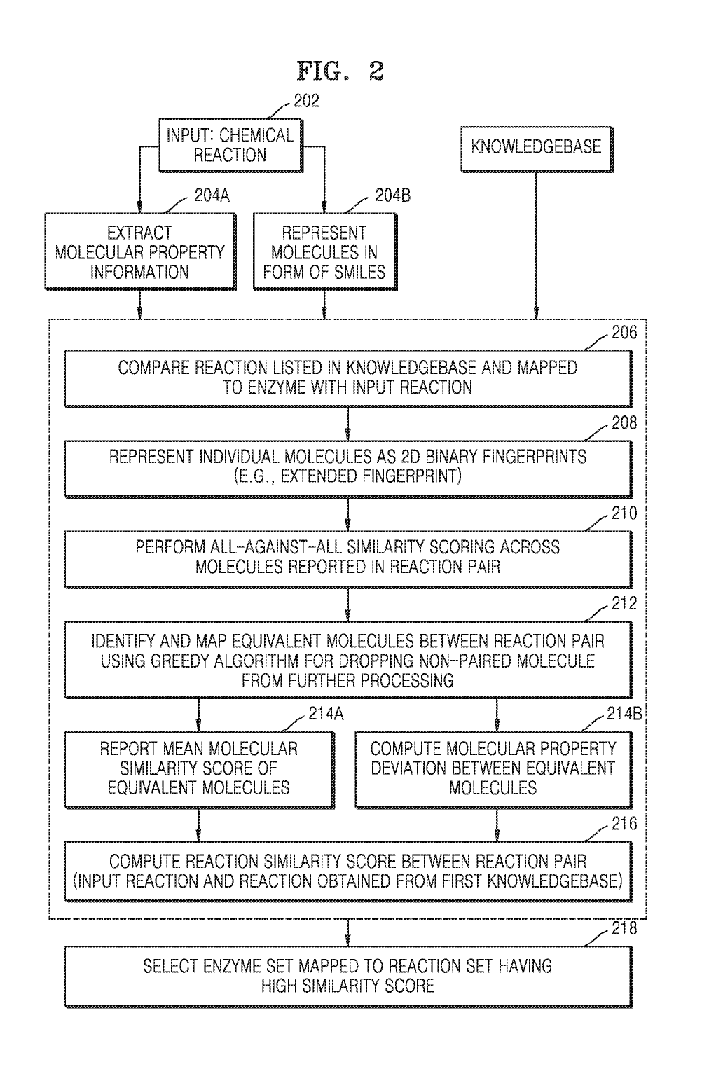

FIG. 2 is a flowchart of a method of selecting an enzyme by transforming an input reaction into a test reaction, according to an embodiment.

Individual substrates/molecules are represented as two-dimensional (2D) binary fingerprints (e.g., an extended fingerprint). In addition, each test reaction is analyzed against all the biochemical reactions included in the first knowledgebase. Reaction pair(s) is/are formed including the test reaction and the similar biochemical reactions from the first knowledgebase. All-against-all similarity scoring is performed across molecules reported in the reaction pair(s). Identification and mapping of equivalent molecules between the reaction pair(s) is performed using a Greedy algorithm. This helps in dropping a non-paired molecule from further processing, thus reducing overall computational burden. Based on the identification and mapping of equivalent molecules, a mean molecular similarity score m̅ₛ̅ of equivalent molecules is reported. A molecular property deviation between equivalent molecules is also calculated, which includes a mean std. deviation of a substrate mass σ̅ₛ̅ᵥ̅ and a mean std. deviation of charge distribution σ̅_̅{̅c̅d̅}̅.

A reaction similarity score ρ̅ₛ̅ is computed between the reaction pair (the test reaction and a reaction obtained from the first knowledgebase).

The similarity score ρ̅ₛ̅ is computed as below:

ρₛ=f(m̅ₛ̅,σ̅ₛ̅ᵥ̅,σ̅_̅{̅c̅d̅}̅) (1)

where m̅ₛ̅=mean molecular similarity (mean mol. similarity),

σ̅ₛ̅ᵥ̅=a mean standard deviation of a substrate mass (mean std. deviation of substrate mass), and
σ̅_̅{̅c̅d̅}̅=a mean standard deviation of charge distribution (mean std. deviation of charge distribution).

Next, based on the similarity score, the enzyme(s) associated with similar biochemical reaction(s) are selected from the first knowledgebase for the next stage of the enzyme assessment.

More specifically, referring to FIG. 2, in operation 202, an input reaction is received.

In operation 204A, molecular property information is extracted from the input reaction.

In operation 204B, molecule(s) associated with the input reaction is/are represented in the form of the SMILES.

In operation 206, a reaction listed in the first knowledgebase and mapped to an enzyme is compared with the input reaction.

In operation 208, individual molecules are represented as 2D binary fingerprints (e.g., an extended fingerprint).

In operation 210, all-against-all similarity scoring is performed across molecules reported in the reaction pair(s).

In operation 212, identification and mapping of equivalent molecules between the reaction pair(s) is performed using a Greedy algorithm for dropping a non-paired molecule from further processing.

In operation 214A, a mean molecular similarity score of the equivalent molecules is reported.

In operation 214B, a molecular property deviation between the equivalent molecules is computed.

In operation 216, the reaction similarity score is computed between the reaction pair (the input reaction and a reaction obtained from the first knowledgebase).

In operation 218, an enzyme set mapped to a reaction set having a high similarity score is selected.

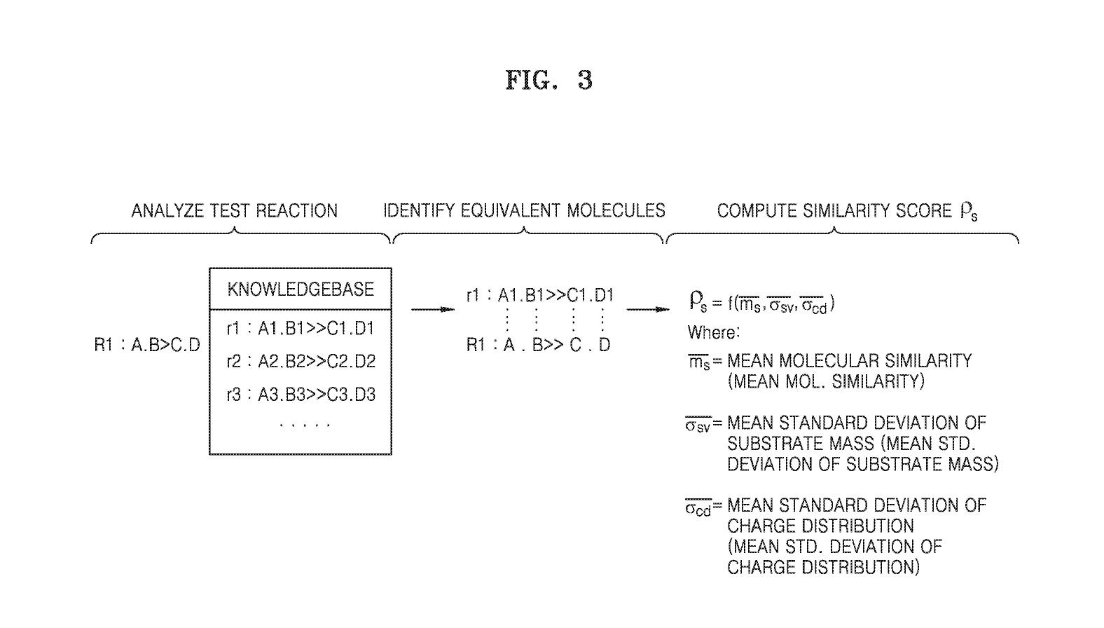

Operations 102 through 106 may refer to FIG. 3.

FIG. 3 is a view for describing computation of a similarity score between a reaction obtained from a knowledgebase and an input reaction, according to an embodiment.

Referring to FIG. 3, for an input reaction R1, test reactions r1, r2, r3, etc., existing in the knowledgebase are analyzed. Molecules equivalent to molecules of the input reaction R1 among the test reaction r1, the test reaction r2, and the test reaction r3 are identified, and as a result, the test reaction r1 having the identified equivalent molecules and the input reaction R1 are determined as a reaction pair. Then, a similarity score between the reaction pair (the input reaction R1 and the test reaction r1) is computed. The similarity score may be computed, for example, using Equation 1.

Referring back to FIG. 1, in operation 108, conserved residue(s) of the selected associated enzyme(s) is/are computationally selected. Once the enzyme(s) is/are selected (operation 106), a sequence of the same is obtained from a second knowledgebase. In an embodiment, 3D coordinates of the selected enzyme(s) is/are also obtained.

In an embodiment, the second knowledgebase includes protein sequences, gene sequences, protein structures, or a combination thereof.

In an embodiment, the computational selection of the conserved residue(s) is performed by:

(a) identifying sequence homologues of the selected associated enzyme(s) from the second set of the knowledgebase. First, sequence homologues of the selected enzyme(s) are obtained from the second set of the knowledgebase. The identification of the sequence homologues is performed through sequence homology search algorithm(s). Redundancy in the identified sequence homologues is removed, and the selected enzyme(s) is/are aligned to the homologues of the selected enzyme(s). This step also helps in reducing the computational data;
(b) scoring a residue position for conservation of each amino acid/residue of the selected associated enzyme(s) with reference to the identified sequence homologues. The scoring of the residue position is computed by one or more conservation scoring methods; and
(c) selecting conserved residues of the selected associated enzyme(s) based on the score of the residue position. The selection of the conserved residue(s) is/are based on a threshold value for the computed score of the residue position.

In operation 110, the conserved residues of the selected one or more associated enzymes are divided into a plurality of sub-structures (or sub-substructures). Such division is performed by using a clustering algorithm including, but not limited to, K-means, Fuzzy C-means, Hierarchical clustering, Mixture of Gaussians, etc.

In operation 112, the residue(s) showing high preference or affinity for substrate binding onto the enzyme is/are computationally selected. This operation includes performing an assessment of binding of one or more substrates received in the test reaction onto each of the sub-structures, in order to determine preference for substrate binding onto the enzyme. Then, the residue(s) showing high preference for substrate binding onto the enzyme is/are selected based on the binding assessment of the substrate.

In operation 114, a mutation impact score is computed for each of the selected one or more residues. The mutation impact score provides insight regarding the functional impact of changing a residue at a given position of the enzyme. The process includes computing a functional impact of the given residue in the selected enzyme(s) based on (a) the conservation score of an amino acid, and (b) a substrate affinity of an amino acid residue.

In an embodiment, the computation of a functional impact ψ₁ of a residue in a given enzyme may be performed using:

Ψ₁=f(S_{cons},S_{aff}) (2)

where S_{cons}=a conservation score of a residue at a given position (a scale between 0 and 1), and
S_{aff}=a substrate affinity of a residue to its corresponding sub-structure (a scale between 0 and 1).

As an example of Equation 2 for this purpose, Equation 3 may be used:

Ψ₁=\sqrt{S_{cons}×S_{aff}} (3)

Next, the mutation impact score ψ of a residue in the enzyme is computed based on (a) the computed functional impact of the residue, and (b) a deviation of the input substrate from the native substrate.

According to an embodiment, using Equation 4, the mutation impact score LP of the residue in the enzyme may be computed as follows:

$$Ψ = \frac{{Ψ}_{1}}{1 + γ \cdot {s}_{dev}} \qquad ( 4 )$$

where ψ₁=a functional impact of a residue,
S_{dev}=a factor reporting a deviation of an input from the native substrate, and
γ=a weighing factor and a function of a distance between the current residue position from the catalytic site residues. γ is commonly set to 1, but may be set to another value.

In operation 116, the residue(s) are ranked based on the computed mutation impact score and, the enzyme(s) having high ranked residue(s) are selected for engineering and optimization of the input reaction.

According to an embodiment, the enzyme(s) may be selected in operation 116 for optimization for catalysis of the biochemical reaction(s). The optimization and engineering of the selected enzyme(s) includes changing the residue(s) at corresponding specific positions on the enzyme(s). The change(s) in a residue's position for the optimization affects the functionality of the enzyme. By doing so, the desired purpose of enhancing/reducing kinetics of the enzyme(s) or enhancing/reducing stability of enzyme(s) may be achieved.

As an example, the test reaction (conversion of Tetrafluoromethane to (Trifluoromethyl)oxidanyl) created for the input reaction may be assumed as below.

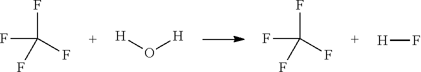

After operations 102 through 118 are performed, Formaldehyde (FA) dehydrogenase (FAcD) is selected to engineer and optimize the test reaction. The top five (5) residues of the FAcD having a high computed mutation impact score were selected for optimization, and are listed in Table 1.

TABLE 1

| residue | position | preference |
|---|---|---|
| ARG | 111 | 1 |
| TYR | 202 | 1 |
| TRP | 264 | 2 |
| VAL | 115 | 2 |
| ASP | 134 | 3 |

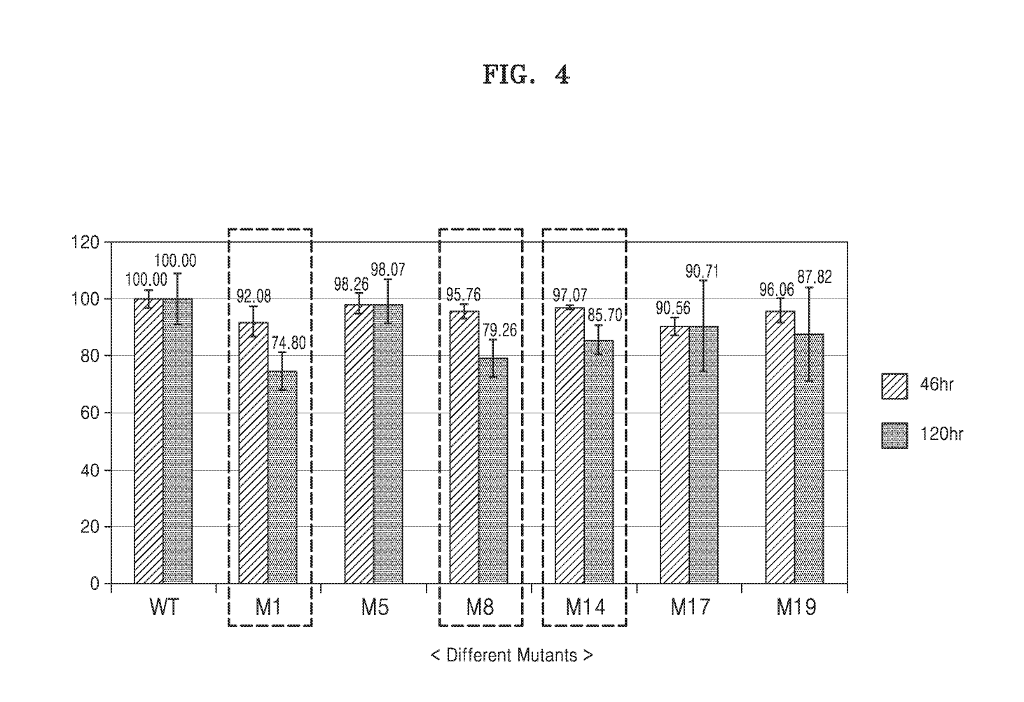

When R111 (ARG) was used for optimization, a resultant mutation reported a 25% increase in the efficacy of FAcD. However, further mutations at the site also reported enhanced activity as represented in the graph of FIG. 4. M1, M8 and M14 show significant enhancement in the efficacy of the enzyme.

The current embodiments may provide a device for performing methods as will be described below.

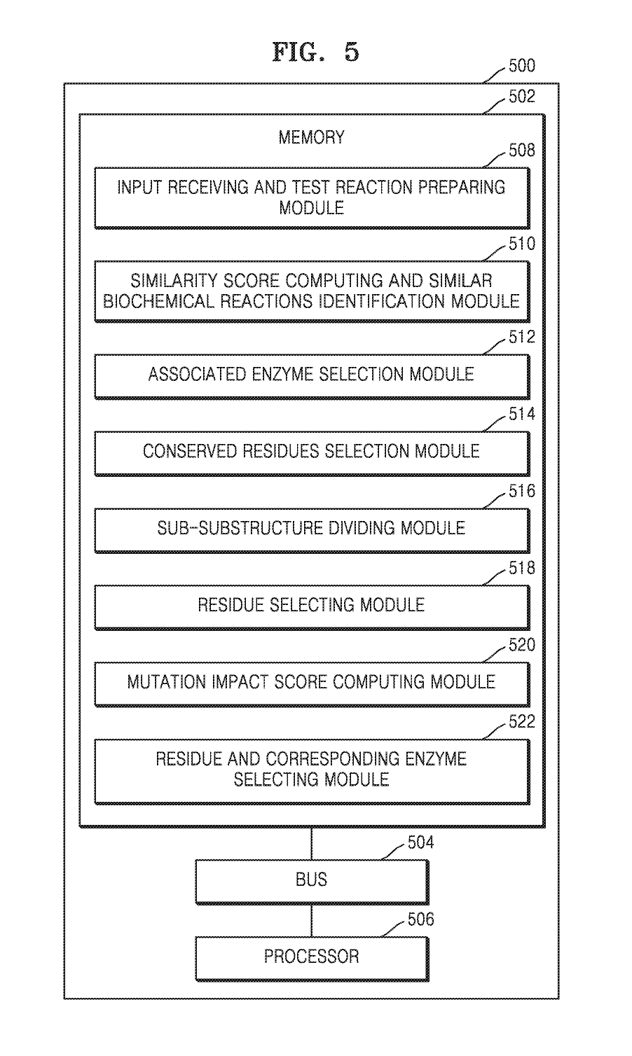

FIG. 5 is a block diagram of a device for selecting and optimizing an enzyme that catalyzes an input reaction, according to an embodiment.

A device 500 may include a processor 506 and a memory 502 connected to the processor 506 via a bus 504.

The processor 506 may be implemented as any type of computational circuit, and may include, for example, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a digital signal processor (DSP), any other type of processing circuit, or a combination thereof.

The memory 502 may include a plurality of modules stored in the form of an executable program which instructs the processor 506 to perform operations illustrated in FIG. 1. The memory 502 may include an input-receiving and test reaction preparation module 508, a similarity score computation and similar biochemical reactions identification module 510, an associated enzyme selection module 512, a conserved residues (of the selected enzyme) selection module 514, a sub-substructure(s) (of the conserved residue) dividing module 516, a residue selection module 518, a mutation impact score computation module 520, and a residue and corresponding enzyme selection module 522.

Computer memory elements may include any suitable memory device(s) for storing data and an executable program, such as a read-only memory (ROM), a random-access memory (RAM), an erasable programmable read-only memory (EPROM), an electrically erasable programmable read-only memory (EEPROM), a hard drive, a removable media drive for handling memory cards, and the like. The current embodiments may be implemented in conjunction with program modules, including functions, procedures, data structures, and application programs, for performing tasks or defining abstract data types (ADTs) or low-level hardware contexts. The above-described executable program stored on any of the above-mentioned storage media may be executable by the processor 506.

The input-receiving and test reaction preparation module 508 instructs the processor 506 to perform operation 102 of FIG. 1.

The similarity score computation and similar biochemical reactions identification module 510 instructs the processor 506 to perform operation 104 of FIG. 1.

The associated enzyme selection module 512 instructs the processor 506 to perform operation 106 of FIG. 1.

The conserved residues (of the selected enzyme) selection module 514 instructs the processor 506 to perform operation 108 of FIG. 1.

The sub-structure(s) (of the conserved residue) dividing module 516 instructs the processor 506 to perform operation 110 of FIG. 1.

The residue selection module 518 instructs the processor 506 to perform operation 112 of FIG. 1.

The mutation impact score computation module 520 instructs the processor 506 to perform operation 114 of FIG. 1.

The residue and corresponding enzyme selection module 522 instructs the processor 506 to perform operation 116 of FIG. 1.

According to an embodiment, the memory of the device 500 may further include an additional element such as an enzyme optimization module, and the like, though not shown in FIG. 5. For example, the enzyme optimization module may instruct the processor 506 to optimize a selected enzyme for catalysis of an input reaction, based on a mutation impact score of a residue.

A device according to the embodiments may include a processor, a memory for storing program data and executing it, a permanent storage such as a disk drive, a communications port for communicating with external devices, and user interface devices, such as a touch panel, a key, a button, etc. Methods implemented with a software module or algorithm may be stored as computer-readable codes or program instructions executable on the processor on computer-readable recording media. Examples of the computer-readable recording media may include a magnetic storage medium (e.g., read-only memory (ROM), random-access memory (RAM), floppy disk, hard disk, etc.) and an optical medium (e.g., a compact disc-ROM (CD-ROM), a digital versatile disc (DVD), etc.) The computer-readable recording medium may be distributed over network-coupled computer systems so that a computer-readable code is stored and executed in a distributed fashion. The medium may be read by a computer, stored in a memory, and executed by a processor.

The current embodiments may be represented by block components and various process operations. Such functional blocks may be implemented by various numbers of hardware and/or software components which perform specific functions. For example, the present disclosure may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements, the current embodiment may be implemented with any programming or scripting language such as C, C++, Java, assembler, or the like, with the various algorithms being implemented with any combination of data structures, objects, processes, routines, or other programming elements. Functional aspects may be implemented as an algorithm executed in one or more processors. Furthermore, the current embodiment may employ any number of conventional techniques for electronics configuration, signal processing and/or control, data processing, and the like. The term “mechanism”, “element”, “means”, or “component” is used broadly and is not limited to mechanical or physical embodiments. The term may include a series of routines of software in conjunction with the processor or the like.

Particular executions described in the current embodiment are merely examples, and do not limit a technical range with any method. For the sake of brevity, conventional electronics, control systems, software development and other functional aspects of the systems may not be described in detail. Furthermore, the connecting lines, or connectors shown in the various figures presented are intended to represent example functional relationships and/or physical or logical couplings between the various elements.

In the present disclosure (especially, in the claims), the use of “the” and other demonstratives similar thereto may correspond to both a singular form and a plural form. Also, if a range is described in the present disclosure, the range has to be regarded as including inventions adopting any individual element within the range (unless described otherwise), and it has to be regarded as having written in the detailed description of the disclosure each individual element included in the range. Unless the order of operations of a method is explicitly mentioned or described otherwise, the operations may be performed in an appropriate order. The order of the operations is not limited to the order the operations as mentioned.

So far, embodiments of the present disclosure have been described. It would be understood by those of ordinary skill in the art that the present disclosure may be implemented in a modified form without departing from the essential characteristics of the present disclosure. Therefore, the disclosed embodiments should be considered in an illustrative sense rather than a restrictive sense. The scope of the embodiments will be in the appended claims, and all of the differences in the equivalent range thereof should be understood to be included in the embodiments.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A method of selecting and optimizing an enzyme for catalysis, the method comprising:
receiving an input reaction;
preparing a test reaction to be searched for in a first knowledgebase for the input reaction;
identifying similar biochemical reactions and associated enzymes for the test reaction from the first knowledgebase based on a similarity score;
selecting one or more associated enzymes based on a similarity score of at least one of the identified similar biochemical reactions and a substrate associated with the test reaction;
computationally selecting conserved residues of the one or more selected associated enzymes;
dividing the conserved residues of the one or more selected associated enzymes into a plurality of sub-structures;
computationally selecting one or more residues showing an affinity for substrates binding to the one or more selected associated enzymes;
computing a mutation impact score for each of the one or more selected residues; and
selecting a residue of the one or more selected associated enzymes for engineering and optimizing catalysis of the input reaction, based on the computed mutation impact score.

2. The method of claim 1, wherein the input reaction comprises at least one of one or more chemical reactions, one or more partial chemical reactions, one or more chemical pathways, and one or more substrates for one or more enzymes to be selected.

3. The method of claim 1, wherein the preparing of the test reaction comprises:
analyzing the received input reaction to identify at least one of one or more chemical reactions and one or more associated substrates from the first knowledgebase; and
transforming the identified at least one of the one or more chemical reactions and the one or more associated substrates into the test reaction.

4. The method of claim 1, wherein the first knowledgebase comprises at least one of substrates and enzymes corresponding to a set of chemical reactions and enzymes, and a list of enzymes, and
the substrates associated with the test reaction are obtained from the first knowledgebase.

5. The method of claim 1, wherein received inputs are transformed into one test reaction for each input reaction.

6. The method of claim 1, wherein the similarity score is computed based on molecular properties and molecular signatures of the substrate associated with the test reaction.

7. The method of claim 6, wherein the molecular properties comprise at least one of a mass of the substrate, a charge distribution on the substrate, a volume of the substrate, and stereochemistry of the substrate, and
the molecular signatures comprise chemical descriptors of the substrate.

8. The method of claim 1, wherein the one or more selected associated enzymes are ranked based on the similarity score, and
the ranked enzymes are selected based on a threshold value for the similarity score.

9. The method of claim 1, wherein the computational selection of the conserved residues of the one or more selected associated enzyme comprises:
identifying sequence homologues of the one or more selected associated enzymes from a second knowledgebase;
scoring a residue position for conservation of each residue of the one or more selected associated enzymes with reference to the identified sequence homologues; and
selecting conserved residues of the one or more selected associated enzymes based on a score of the residue position.

10. The method of claim 9, wherein the identifying of the sequence homologues comprises:
obtaining sequence homologues of the one or more selected associated enzymes from the second knowledgebase;
computationally identifying sequence homologues of the selected associated enzymes;
removing unnecessary sequence homologues from the identified sequence homologues; and
aligning the remaining homologues to the one or more selected associated enzymes of the test reaction.

11. The method of claim 9, wherein the scoring of the residue position is performed based on one or more conservation scoring methods.

12. The method of claim 9, wherein the second knowledgebase comprises at least one of protein sequences, gene sequences, and protein structures.

13. The method of claim 9, wherein the conserved residues of the one or more selected associated enzymes are selected based on a threshold value for the score of the residue position.

14. The method of claim 1, wherein the dividing of the conserved residues is performed based on a clustering algorithm.

15. The method of claim 1, wherein the computational selection of the one or more residues showing an affinity comprises:
performing assessment of binding of the substrates associated with the test reaction onto each of the sub-structures, in order to determine preference for substrate binding onto the one or more selected associated enzymes; and
selecting the one or more residues showing an affinity for substrate binding onto the enzyme based on the binding assessment.

16. The method of claim 1, wherein the computing of the mutation impact score comprises:
computing a functional impact of a given residue in the one or more selected associated enzymes, based on the conservation score of an amino acid and substrate affinity of an amino acid residue; and
computing the mutation impact score based on the computed functional impact and a deviation of an input substrate from a native substrate.

17. The method of claim 1, wherein the one or more selected associated enzymes are selected based on a threshold value for a similarity score of the one or more residues.

18. The method of claim 1, further comprising optimizing the one or more selected associated enzymes having highly ranked residues for catalysis of the input reaction,
wherein the optimizing of the one or more selected associated enzymes comprise of changing the one or more residues at corresponding specific positions on the one or more enzymes.

19. A device for selecting and optimizing an enzyme for catalysis, the device comprising:
a memory; and
one or more processors connected to the memory and configured to:
receive an input reaction;
prepare a test reaction to be searched for in a first knowledgebase for the input reaction,
identify similar biochemical reactions along with associated enzymes for the test reaction from the first knowledgebase based on a similarity score,
select one or more associated enzymes based on a similarity score of at least one of the identified similar biochemical reactions and a substrate associated with the test reaction,
computationally select conserved residues of the one or more selected associated enzymes,
divide the conserved residues of the one or more selected associated enzymes into a plurality of sub-structures,
computationally select one or more residues showing an affinity for substrates binding onto the one or more selected associated enzymes,
compute a mutation impact score for each of the one or more selected residues, and
select, based on the computed mutation impact score, one or more residues of the one or more selected associated enzymes for engineering and optimizing catalysis of the input reaction.

20. The device of claim 19, wherein the processors are configured to optimize the one or more selected associated enzymes for catalysis of the input reaction based on the mutation impact score of the one or more residues.
